(19) United States
(12) Patent Application Publication
(10) Pub. No.: US 2024/0399185 A1
(43) Pub. Date: Dec. 5, 2024

(54) FORMULATION AND METHOD FOR CONTROLLING BIOREFINERY WASTE HAZARDS

(71) Applicant: Baker Hughes Oilfield Operation LLC, Housten, TX (US)

(72) Inventors: Sankaran Murugesan, Kety, TX (US); Jerry J. Weers, Richmond, TX (US); Kekeli A. Ekoue-Kovi, Rosenberg, TX (US)

(73) Assignee: Baker Hughes Oilfield Operation LLC, Housten, TX (US)

(21) Appl. No.: 18/203,587

(22) Filed: May 30, 2023

(51) Int. Cl. A62D 3/30; B09B 3/70; C02F 11/00

(52) U.S. Cl. CPC A62D 3/30; B09B 3/70; C02F 11/00; A62D 2101/20; C02F 2103/36

(57) ABSTRACT

A suppressant formulation for controlling the exothermicity of biomass waste includes at least one free-radical scavenger and at least one solvent selected. The solvent can be an organic solvent, water, or combinations thereof. In another aspect, the disclosure relates to a suppressant formulation that includes a preformulated suppressant mixture and at least one organic carbonate solvent characterized by a high flash point. The preformulated suppressant mixture includes at least one free-radical scavenger, at least one metal deactivator, and a solvent selected from the group consisting of organic solvents, water, and combinations thereof. In yet another aspect, the disclosure relates to a method for controlling the exothermicity of biomass waste by applying the suppressant formulation to a final biomass waste product through internal (such as blending) and external (such as spray-coating) processes.

### FIELD OF THE INVENTION

This invention generally relates to the mitigation of hazards associated with biorefinery processing and, more particularly, but not by way of limitation, to a formulation and method for controlling hazards associated with the self-exothermicity of biomass waste produced by biorefineries.

### BACKGROUND OF THE INVENTION

The energy sector is experiencing an increasing push toward renewable resources as a solution to fossil fuel depletion and environmental pollution. Various types of plant-and animal-based biomass, including grasses, trees, agricultural crops, animal wastes, and municipal waste sludge, are of particular interest as renewable sources of fuel and other products. By transforming organic biomass into useful products, members of the energy sector can mitigate environmental degradation and contribute to the overall conservation of resources.

A biorefinery is a facility used to process and transform organic biomass into useful products such as biofuels (e.g., bioethanol, biomethanol, biogas, syngas, and biodiesel); chemicals (e.g., biosurfactants, biopolymers, and biopigments); and energy. A substantial portion of the energy demand for biorefineries is presently supplied by biomass. As an initial step in the biorefinery process, organic waste is separated from inorganic waste to obtain an organic feedstock. One or more catalysts are then added to the organic feedstock to break it down. These catalysts may include inorganic catalysts (such as clay, zeolite, and diatomaceous earth-based catalysts) and organic-inorganic hybrid catalysts.

In subsequent steps of the biorefinery process, the feedstock is refined and transformed into useful materials, with waste materials including spent inorganic catalysts and adsorbents as byproducts. The adsorption of unsaturated hydrocarbons during the biorefinery process often contaminates biomass waste materials, making them more self-exothermic. The contaminated biomass waste materials are removed from the biorefinery and dewatered into a final solid. The composition of this final solid will vary depending, in part, on the type of biomass that was initially introduced into the biorefinery.

A recurring problem in the disposal of contaminated biomass waste is the tendency of the waste products to auto-ignite or create smoke during transport or at the disposal site. The underlying problem is that the biomass waste oxidizes in the presence of air, thereby forming free radicals that are prone to exothermic reactions. If biomass waste materials ignite during transport, landfills may refuse to permit those materials to be dumped. If this occurs, the materials either remain in the transporting vehicle or must be dumped elsewhere. The inability to efficiently dispose of biomass waste materials is costly to biorefineries, both in terms of time and money.

Prior attempts to mitigate the fire and smoke risks of contaminated biomass waste have lacked reliability. For example, a fine powder derived from rice husks is sometimes used to cover the surface of biomass waste materials to reduce contact with air. This powder, however, is not effective in controlling the self-exothermicity of the waste materials resulting from the presence of unsaturated hydrocarbon contaminants. A need exists, therefore, for an additive to biomass waste materials that addresses the presence of unsaturated hydrocarbon contaminates through chemical intervention. The present disclosure is directed at these and other deficiencies in the prior art.

### SUMMARY OF THE INVENTION

In some embodiments, the present disclosure is directed to a suppressant formulation for controlling the self-exothermicity of a treated biomass waste product. The suppressant formulation includes at least one free-radical scavenger and at least one solvent. The solvent can be an organic solvent, water, or combinations thereof. The suppressant formulation optionally includes at least one metal deactivator, wherein the at least one metal deactivator is selected from the group consisting of carboxylic acids, alkylphenol-formaldehyde-polyamine condensation polymers, salicylaldehyde-polyamine condensation products, triazoles, thiadiazoles, and combinations thereof.

In other embodiments, this disclosure is directed to a suppressant formulation that includes a preformulated suppressant mixture and at least one organic carbonate solvent characterized by a high flash point. The preformulated suppressant mixture includes at least one free-radical scavenger, at least one metal deactivator, and a solvent selected from the group consisting of organic solvents, water, and combinations thereof.

In other embodiments, this disclosure is directed to a method for controlling the exothermicity of biomass waste. The method includes the steps of providing a suppressant formulation, isolating the final biomass waste product, and applying the suppressant formulation to the final biomass waste product to produce a treated biomass waste product. The suppressant formulation includes at least one free-radical scavenger. In these embodiments, the suppressant formulation optionally includes an organic carbonate solvent, such as propylene carbonate, and a metal deactivator, such as a carboxylic acid.

### BRIEF DESCRIPTION OF THE DRAWINGS

The above and other objects and advantages of this invention may be more clearly seen when viewed in conjunction with the accompanying drawing wherein:

FIG. 1 is a flowchart for an exemplary method of processing biomass waste from a biorefinery.

### DETAILED DESCRIPTION

The self-ignition of biomass waste is typically caused by free radicals formed during the oxidation of unsaturated hydrocarbons. It has been discovered that a suppressant formulation with a free-radical scavenger (antioxidant) can be used to control the self-exothermicity of contaminated biomass waste, thereby reducing the fire and smoke hazards typically associated with disposal of such waste. In exemplary embodiments, self-exothermicity suppressant formulations include at least one free-radical scavenger component and a solvent component.

Suitable free-radical scavengers are capable of suppressing the oxidation that can lead to runaway exothermicity by removing free radicals in the biomass waste that can lead to self-ignition. In some embodiments, the free-radical scavenger component may include one or more hindered phenols such as a butylated hydroxytoluene (BHT), tocopherols, aromatic amines, oxygen scavengers, and peroxide scavengers. Suitable peroxide scavengers may include organic sulfide compounds, phosphine compounds, phosphate compounds, diaminomethanes, and combinations thereof. For free-radical scavenger components that include multiple free radical scavengers, there are no particular limits as to the relative proportions of the various free-radical scavengers.

The solvent component provides greater control over the self-exothermicity of the contaminated biomass waste. The solvent(s) cover and exfoliate the biomass waste, thereby causing inorganic materials in the biomass waste, such as clay-like and diatomaceous earth-based materials, to swell. This swelling helps the free-radical scavengers penetrate deeper into the inorganic materials. The addition of the solvent(s) therefore allows the free-radical scavengers to more efficiently remove the types of oxidant radicals that can lead to self-exothermicity.

The type of biomass initially processed at the biorefinery will impact the flammability of the resulting biomass waste. In some embodiments, the solvent component is characterized by a high flash point, so as not to lower the temperature at which the biomass waste could ignite in air. In these embodiments, the solvent(s) optimally have a flash point greater than 100° F. Organic carbonate solvents with lower flash points, such as dimethyl carbonate (DMC) with a flash point of 63° F. or diethyl carbonate with a flash point of 77° F., may be less useful for controlling the self-exothermicity of the biomass waste.

In some embodiments, the solvent component is also characterized by a resistance to rapid evaporation under anticipated temperatures, pressures, and humidity.

In some embodiments, the solvent component may include at least one solvent selected from the group consisting of organic solvents, water, and combinations thereof. The solvent component may include one or more of the following organic carbonate solvents: dialkyl carbonates, cyclic carbonates, and combinations thereof. Suitable organic carbonate solvents include but are not necessarily limited to propylene carbonate, ethylene carbonate, glycerol carbonate, dibutyl carbonate, and combinations thereof. For solvent components that include multiple organic carbonate solvents, there are no particular limits as to the relative proportions of organic carbonates when they are used together. For example, one non-restrictive suitable solvent component includes about 25 weight (wt.) % glycerol carbonate in propylene carbonate (the balance). Another non-limiting alternative is about 25 wt. % ethylene carbonate in propylene carbonate (the balance). In a different non-limiting embodiment, about 21 wt. % glycerol carbonate in dibutyl carbonate (as the balance) is a suitable proportion.

In non-restrictive combinations, the proportion of the free-radical scavenger to the solvent within the suppressant formulation can be between about 1 to about 10 wt. % free-radical scavenger and about 90 to about 99 wt. % solvent. For example, the suppressant formulation can include about 1 wt. % free-radical scavenger with about 99 wt. % solvent. In another non-limiting alternative, the suppressant formulation includes about 5 wt. % free-radical scavenger with about 95 wt. % solvent. In another embodiment, the suppressant formulation includes about 7 wt. % free-radical scavenger to about 93 wt. % solvent. In yet another embodiment, the suppressant formulation includes about 10 wt. % free-radical scavenger and about 90 wt. % solvent.

In some embodiments, the suppressant formulation further includes at least one metal deactivator. In such cases, the at least one metal deactivator may be a metal chelant. In those embodiments, the metal deactivator can be selected from the group consisting of carboxylic acids such as citric acid, glycolic acid, thioglycolic acid, and lactic acid; alkylphenol-formaldehyde-polyamine condensation polymers; salicylaldehyde-polyamine condensation products; triazoles such as benzotriazole and tolytriazole; thiadiazoles; and combinations thereof.

In some embodiments, the suppressant formulation includes a preformulated suppressant mixture that is blended with at least one organic carbonate solvent characterized by a high flash point. In such embodiments, the preformulated suppressant mixture may include a free-radical scavenger component, a metal deactivator component, and a solvent component. The solvent component may include at least one solvent selected from the group consisting of organic solvents, water, and combinations thereof.

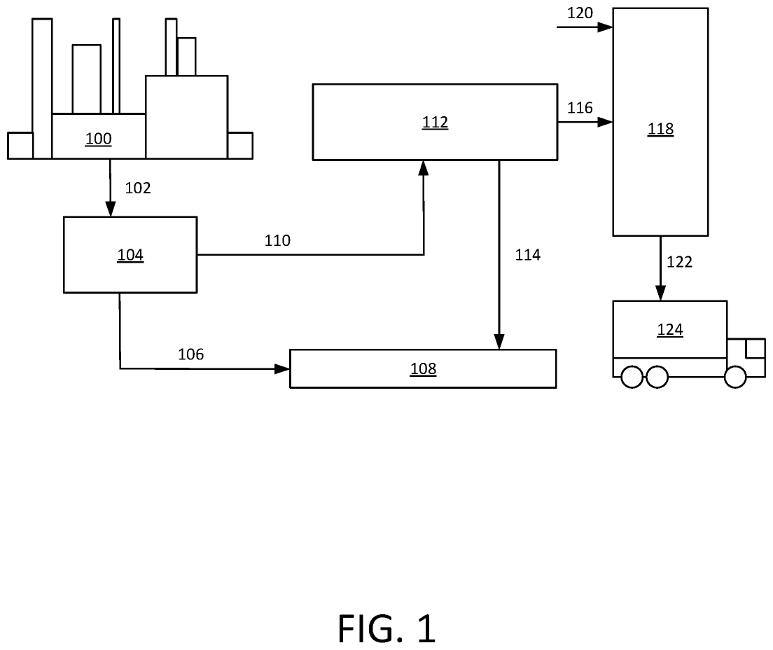

Turning to FIG. 1, shown therein is a flow diagram for an exemplary process for treating and removing biomass waste from a biorefinery 100. Once the processing of a biomass at the biorefinery 100 is complete, biomass waste 102 is produced and isolated. The biomass waste 102 may be contaminated with unsaturated hydrocarbons. The biomass waste 102 is diverted into a primary dewatering unit 104, where an initial portion of water 106 is removed from the biomass waste 102 and sent to a wastewater treatment plant 108. The remaining waste, in the form of a sludge 110, is transferred from the primary dewatering unit 104 to a secondary dewatering unit 112, where additional water 114 is removed and sent to the wastewater treatment plant 108. The remaining waste from the secondary dewatering unit 112 is in the form of a final biomass waste product 116. Although the final biomass waste product 116 is primarily composed of solids, it may nonetheless include liquids, fluids and gases that were not removed in earlier processing steps.

To safely control the self-exothermicity of the final biomass waste product 116, the final biomass waste product 116 is treated with the suppressant formulation 120 at a treatment module 118 before a treated biomass waste product 122 is transported in a container 124 to a disposal site (not shown). In some embodiments, the container 124 is a truck, trailer, ship, or other vehicle. In other embodiments, the container 124 is replaced or supplemented with conveyors, augers, pipelines, or other material handling systems. The treated biomass waste product 122 can be transported to any suitable disposal site, such as landfills, recycling plants, composting centers, and incinerators.

The suppressant formulation 120 can be applied internally, externally, or both internally and externally to the final biomass waste product 116 through one or more application steps. In an exemplary embodiment, the final biomass waste product 116 is blended or mixed with the suppressant formulation 120 by an industrial blender in an internal application process. The amount of suppressant formulation 120 can vary based on the type and composition of the final biomass waste product 116 and the strength and composition of the suppressant formulation 120. Internally mixing the suppressant formulation into the final biomass waste product 116 ensures good distribution of the suppressant formulation 120 throughout the treated biomass waste product 122.

In some embodiments, the suppressant formulation 120 is blended into the final biomass waste product 116 in an amount sufficient to bring the concentration of the solvent component within the treated biomass waste product 122 to between about 1 and about 20 wt. %. In other embodiments, the treated biomass waste product 122 includes between about 5 and about 15 wt. % solvent. In yet another embodiment, the treated biomass waste product 122 includes about 10 wt. % solvent. For example, if the suppressant formulation 120 includes about 90 wt. % solvent and about 10 wt. % free-radical scavenger, 100 pounds of treated biomass waste product 122 could include between about 10 pounds solvent, about 1 pound of free-radical scavenger, and about 89 pounds of final biomass waste product 116.

In other embodiments, the treated biomass waste product 122 is produced by externally applying the suppressant formulation 120 to the final biomass waste product 116. For example, a suitable process for an external application of the suppressant formulation 120 includes first placing the final biomass waste product 116 into the container 124 and then coating the exposed portions of the final biomass waste product 116 with the suppressant formulation 120. In another embodiment, the container 124 is filled or coated with the suppressant formulation 120 before the final biomass waste product 116 is placed into the container 124. Pre-treating the walls or interior surfaces of the container 124 ensures that the outside surfaces of the final biomass waste product 116 are in contact with a coating of the suppressant formulation 120. An additional coating of the suppressant formulation 120 can then be applied to the exposed (e.g., upper) surface of the final biomass waste product 116 to increase the amount of surface area contacted by the suppressant formulation 120.

As the final biomass waste product 116 swells following contact with the suppressant formulation 120, untreated portions of the final biomass waste product 116 may be exposed to air. Depending on the amount of final biomass waste product 116, it may be desirable to periodically apply multiple treatments of the suppressant formulation 120 to more fully coat the final biomass waste product 116 as it continues to swell. Subsequent internal and external applications of the suppressant formulation 120 can be made at the treatment module 118, during transport, and following disposal.

In some embodiments, it may be desirable to apply the suppressant formulation 120 with a multistep application process in which the suppressant formulation 120 is first blended internally into the to the final biomass waste product 116 before subsequent external coatings of the suppressant formulation 120 are sprayed or otherwise externally applied to the treated biomass waste product 122.

Once the final biomass waste product 116 has been sufficiently treated with the suppressant formulation 120, the treated biomass waste product 122 can be promptly transported to the disposal site without waiting for an extended activation or reaction.

Thus, in accordance with exemplary embodiments, the present disclosure is directed at a suppressant formulation configured to control the self-exothermicity of biomass was products, where the suppressant formulation includes a free-radical scavenger component and a solvent component. In some embodiments, the suppressant formulation further includes a metal deactivator, such as a metal chelant. Exemplary embodiments include methods of applying the suppressant formulation to the final biomass waste product 116 through internal (e.g., blending), external (e.g., spray-coating), or both internal and external application steps. The suppressant formulation can be further applied to the treated biomass waste product 122 on a periodic basis at the biorefinery, during transport, and at the disposal site.

It is claimed:

1. A suppressant formulation for controlling the self-exothermicity of a treated biomass waste product, the suppressant formulation comprising:
at least one free-radical scavenger; and
at least one solvent selected from the group consisting of organic solvents, water, and combinations thereof.

2. The suppressant formulation of claim 1, wherein the at least one free-radical scavenger is selected from the group consisting of hindered phenols, tocopherols, aromatic amines, oxygen scavengers, peroxide scavengers, and combinations thereof.

3. The suppressant formulation of claim 1, wherein the at least one solvent has a flash point greater than 100° F.

4. The suppressant formulation of claim 1, wherein the at least one solvent is an organic carbonate solvent is selected from the group consisting of dibutyl carbonate, ethylene carbonate, glycerol carbonate, propylene carbonate, and combinations thereof.

5. The suppressant formulation of claim 4, wherein the organic carbonate solvent is propylene carbonate.

6. The suppressant formulation of claim 1, wherein the proportion of the at least one free-radical scavenger to the at least one solvent in the formulation is approximately 1 wt. % free-radical scavenger to approximately 99 wt. % solvent.

7. The suppressant formulation of claim 1 further comprising at least one metal deactivator, wherein the at least one metal deactivator is selected from the group consisting of carboxylic acids, alkylphenol-formaldehyde-polyamine condensation polymers, salicylaldehyde-polyamine condensation products, triazoles, thiadiazoles, and combinations thereof.

8. A suppressant formulation for controlling the self-exothermicity of a treated biomass waste product, the suppressant formulation comprising:
a preformulated suppressant mixture comprising:
at least one free-radical scavenger;
at least one metal deactivator; and
a solvent selected from the group consisting of organic solvents, water, and combinations thereof; and
at least one organic carbonate solvent characterized by a high flash point.

9. A method for reducing the self-exothermicity of a final biomass waste product, the method comprising the steps of:
providing a suppressant formulation, wherein the suppressant formulation comprises at least one free-radical scavenger;
isolating the final biomass waste product; and
applying the suppressant formulation to the final biomass waste product to produce a treated biomass waste product.

10. The method of claim 9, wherein the step of providing the suppressant formulation further comprises providing a suppressant formulation that includes at least one organic carbonate solvent.

11. The method of claim 10, wherein the step of applying the suppressant formulation to the final biomass waste product comprises blending the suppressant formulation into the final biomass waste product to form the treated biomass waste product.

12. The method of claim 10, wherein the step of applying the suppressant formulation to the final biomass waste product comprises externally applying the suppressant formulation onto the final biomass waste product to form the treated biomass waste product.

13. The method of claim 9 further comprising the step of transporting the treated waste product to a disposal site.
